(19) United States
(12) Patent Application Publication
(10) Pub. No.: US 2010/0297494 A1
(43) Pub. Date: Nov. 25, 2010

(54) BATTERY MODULE

(76) Inventor: Chin-Ming CHEN, Gueishan Township (TW)

Correspondence Address: HDLS Patent & Trademark Services, P.O. BOX 220746, CHANTILLY, VA, 20153-0746, US

(21) Appl. No.: 12/469,846

(22) Filed: May 21, 2009

(51) Int. Cl. H01M 2/02

(52) U.S. Cl. 429/179

(57) ABSTRACT

A battery module includes a battery cell, a flexible shell and a supporting seat. The battery cell has a main body and two electrodes extended outwardly from the main body; the flexible shell has an upper and lower lid plates, both of which are connected and cooperated to each other to envelop the battery cell, and which are provided for the electrodes to extend out and respectively have an upper and lower adhesive parts, both of which are adhered to each other; and, the supporting seat is provided for arranging the flexible shell, in which the flexible shell further has an extending part, which is extended from one of the upper, lower adhesive parts towards the supporting seat and has an adhesive layer adhered to the supporting seat by a thermal pressing process, such that the flexible shell and the supporting seat can be connected securely.

### BACKGROUND OF THE INVENTION

1. Field of the Invention

The present invention in general relates to a battery module, and in particular, to a battery module adaptable for electronic device.

2. Description of Prior Art

Currently, secondary battery has already applied to common portable electronic devices comprehensively, for example, mobile phone, digital camera, notebook computer, etc. However, following the trends that the sizes of these portable electronic devices are shrunk and the using time is prolonged, the power of the secondary battery adopted by these devices is increased, whereby there is more waste heat generated from the secondary battery. Therefore, improving the heat dissipation of the secondary battery has become an issue intended to be addressed by each manufacturer urgently.

Please refer to FIG. 1, showing a perspective explosive view of the fixing structure of a prior secondary battery. This prior secondary battery 1a includes a battery cell 11a, a flexible shell 12a, a supporting seat 20a and a plurality of double-sided tapes 30a, in which the flexible shell 12a is adapted for sealing the battery cell 11a. In the meantime, there is a thermally pressing section c′ at outer sides of the flexible shell 12a, while the flexible shell 12a is adhered into the supporting seat 20a through the double-sided tapes 30a.

However, this kind of structure still has several drawbacks in terms of practical use. Firstly, since the connection between the flexible shell 12a and the supporting seat 20a is made by the adhesion of the double-sided tapes 30a, this kind of adhering manner has a doubt concerning the strength and a great influence on the normal operation of the secondary battery 1a. In addition, under an operation of long time, the double-sided tapes 30a are easily lack of stickiness, making the flexible shell 12a falling off from the supporting seat 20a. Secondly, since the secondary battery 1a is sealed in an outer shell (not shown in the figures), when the flexible shell 12a is occurred a loosing off, it is impossible to open the outer shell to undergo a re-adhering process. Renew the secondary battery is the only solution, which raises the using cost of the secondary battery on a large scale.

Furthermore, since the connection between the flexible shell 12a and the supporting seat 20a is made by the adhesion of the double-sided tapes 30a, making the flexible shell 12a contact with the supporting seat 20a only through the double-sided tapes 30a, the heat generated from the battery cell 11a can only be transferred to the supporting seat 20a via the double-sided tapes 30a. By so doing, since the heat-transferring efficiency of the double-sided tapes 30a is poor, the battery cell 11a is easily overheated. Even the whole bottom surface of the flexible shell 12 is covered with double-sided tapes 30a to increase the heat-transferring area, but the help to increase its heat-transferring efficiency is still quite limited, not to mention that the manufacturing cost of the secondary is increased.

Therefore, how to improve and solve the aforementioned problems is an issue intended to be addressed by the inventor.

Accordingly, after a substantially devoted study, in cooperation with the application of relatively academic principles, the inventor has finally proposed the present invention that is designed reasonably to possess the capability to improve the drawback of the prior art significantly.

### SUMMARY OF THE INVENTION

The invention is mainly to provide a battery module, in which an adhesive layer is adhered to a supporting seat, such that a flexible shell can be connected to the supporting seat securely.

Secondly, the invention is to provide a battery module, including a battery cell, a flexible shell and a supporting seat. According to the invention, the battery cell has a main body and two electrodes extended outwardly from the main body; the flexible shell has an upper and lower lid plates, both of which are connected and cooperated to each other to envelop the battery cell, and which are provided for the electrodes to extend out and respectively have an upper and lower adhesive parts, both of which are adhered to each other; and, the supporting seat is provided for arranging the flexible shell, in which the flexible shell further has an extending part, which is extended from one of the upper, lower adhesive parts towards the supporting seat and has an adhesive layer adhered to the supporting seat by a thermal pressing process.

Compared to the prior arts, the invention has the following advantageous functions. Firstly, the drawback of the prior secondary battery, which an insufficiently adhesive strength exists between the flexible shell and the supporting seat, can be solved by thermally pressing the adhesive layer of the extending part to be adhered to the supporting seat, such that the flexible shell is connected securely onto the supporting seat and the connecting strength is enhanced surely. Secondly, another drawback of the fixing structure of the prior secondary battery, which the cause of the reduction of the heat-dissipating efficiency comes from too small heat-transferring area formed by the double-sided tapes, can be solved by the adaptation of the invention. Thirdly, by designing a structure where the extending part of the flexible shell is exposed, the heat generated by the battery cell can be carried away by an external air flown into the supporting seat, such that the cooling performance of the battery module can be further promoted.

### BRIEF DESCRIPTION OF DRAWING

The features of the invention believed to be novel are set forth with particularity in the appended claims. The invention itself, however, may be best understood by reference to the following detailed description of the invention, which describes several exemplary embodiments of the invention, taken in conjunction with the accompanying drawings, in which:

FIG. 1 is a perspective explosive view of the fixing structure of a prior secondary battery;

FIG. 2 is a perspective explosive view of the invention;

FIG. 3 is a manufacturing status perspective view (1) of the invention;

FIG. 4 is a manufacturing status perspective view (2) of the invention;

FIG. 5 is a manufacturing status perspective view (3) of the invention;

FIG. 6 is a manufacturing status perspective view (4) of the invention;

FIG. 7 is a perspective explosive view of the invention;

FIG. 8 is a cross-sectional view along the sectional line “8-8” in FIG. 7;

FIG. 9 is a cross-sectional view of the second embodiment of the invention; and

FIG. 10 is a perspective outer view of another embodiment of the invention.

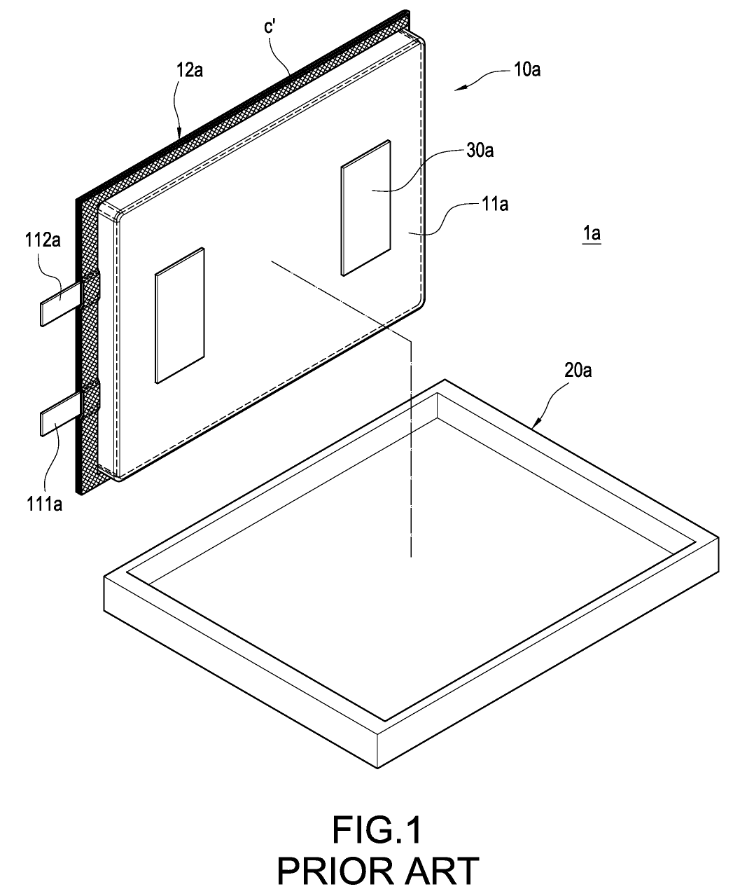

### DETAILED DESCRIPTION OF THE INVENTION

In cooperation with attached drawings, the technical contents and detailed description of the present invention are described thereinafter according to a number of preferable embodiments, not used to limit its executing scope. Any equivalent variation and modification made according to appended claims is all covered by the claims claimed by the present invention.

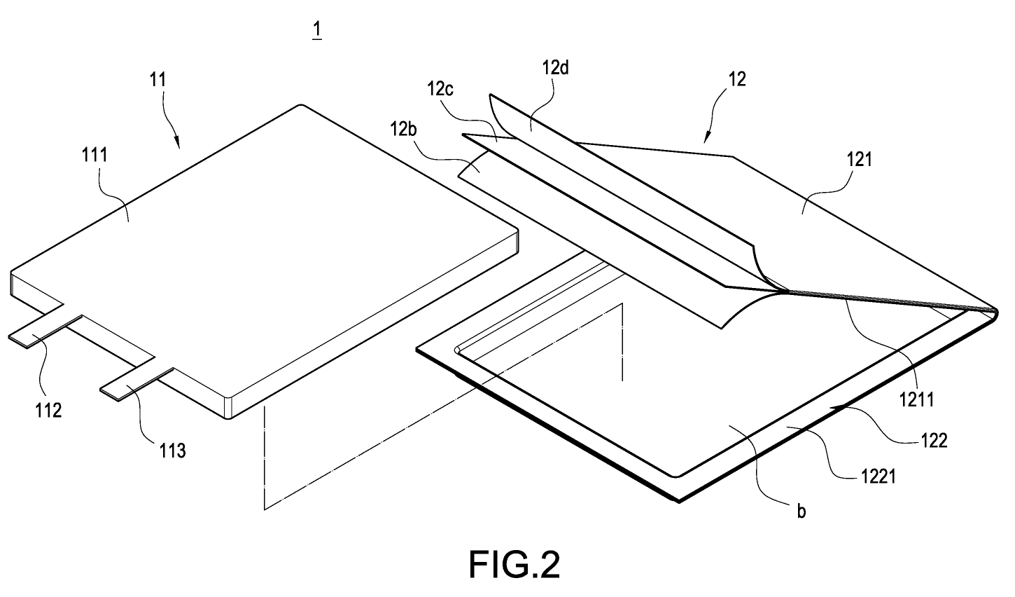

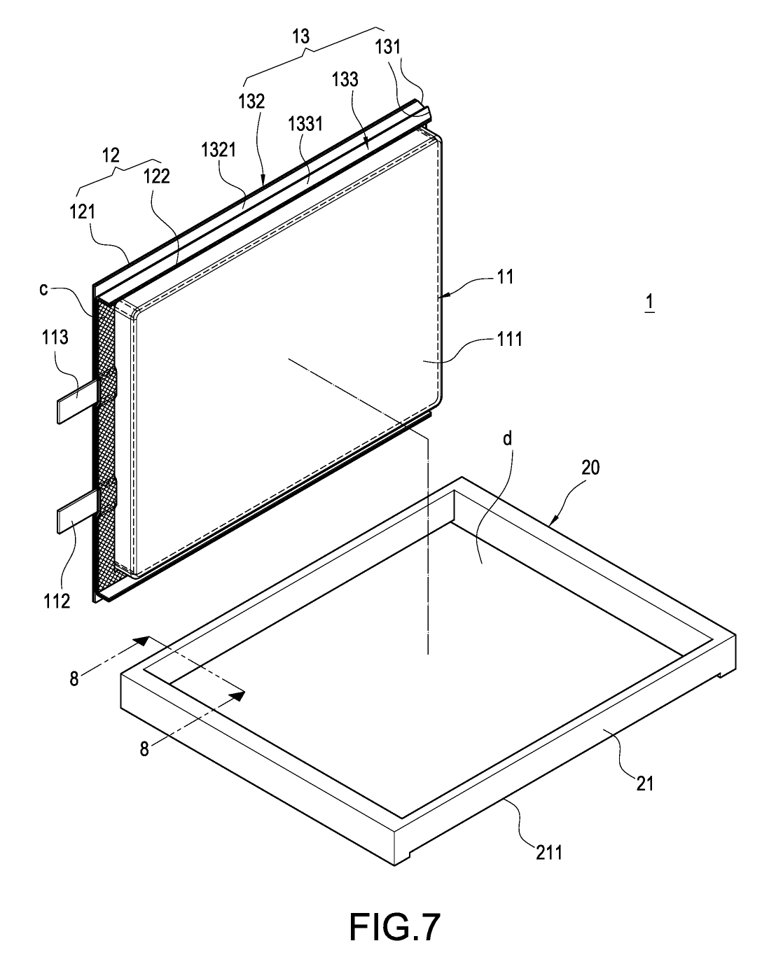

Please refer to FIG. 2, showing a perspective explosive view of the invention. Also, refer to FIG. 7 together. The invention is to provide a battery module 1, including a battery cell 11, a flexible shell 12 and a supporting seat 20.

The battery cell 11 has a main body 111 and two electrodes 112, 113 extended outwardly from the main body 111. These two electrodes 112, 113 respectively are a positive electrode 112 and a negative electrode 113 interspaced with the positive electrode 112. In this embodiment, the main body 111 is a thin cuboid shown as a plate shape, but not limited to this configuration only. The positive electrode 112 and the negative electrode 113 are extended outwardly from one side of this cuboid.

The original shape of the flexible shell 12 is a rectangular sheet, including a polypropylene (PP) layer 12b, an aluminum foil layer 12c overlapped beneath the polypropylene layer 12b and a nylon layer 12d overlapped beneath the aluminum foil layer 12d. The structure of these three layers constitutes this flexible shell 12. In addition, the polypropylene layer 12b can be replaced by another kind of thermoplastic plastic, however, not limited to these kinds of materials only. In addition, the nylon layer 12d is located on the outer surface of the flexible shell 12 and is capable of the functions of wear resistance and protection. One thing needed to mention is that the nylon layer 12d can be skipped during a practical execution.

More specifically, the rectangular sheet is folded to form an upper lid plate 121 of the flexible shell 12 and a lower lid plate 122 connected to the upper lid plate 121. One thing needed to notice is that the polypropylene layer 12b is located at an inside of the flexible shell 12 after being folded. The upper lid plate 121 has an upper adhesive part 1211, while the lower lid part 122 has a lower adhesive part 1221. The upper adhesive part 1211 and the lower adhesive part 1221 are adhered to each other by thermally pressing the polypropylene layers 12b, both of which are faced to each other.

The manufacturing process of the battery module 1 of the invention is described thereinafter. Firstly, an indentation b is formed on the lower lid plate 122 by a stamping process. Then, the battery cell 11 is placed in the indentation b. Next, the upper lid plate 121 is folded and covers the indentation b of the lower lid plate 122. Finally, the upper lid plate 121 and the lower lid plate 122 are closed to each other by thermally pressing the upper adhesive part 1211 and the lower adhesive part 1221 together, while the surface layers of both adhesive parts are all the polypropylene layers 12b.

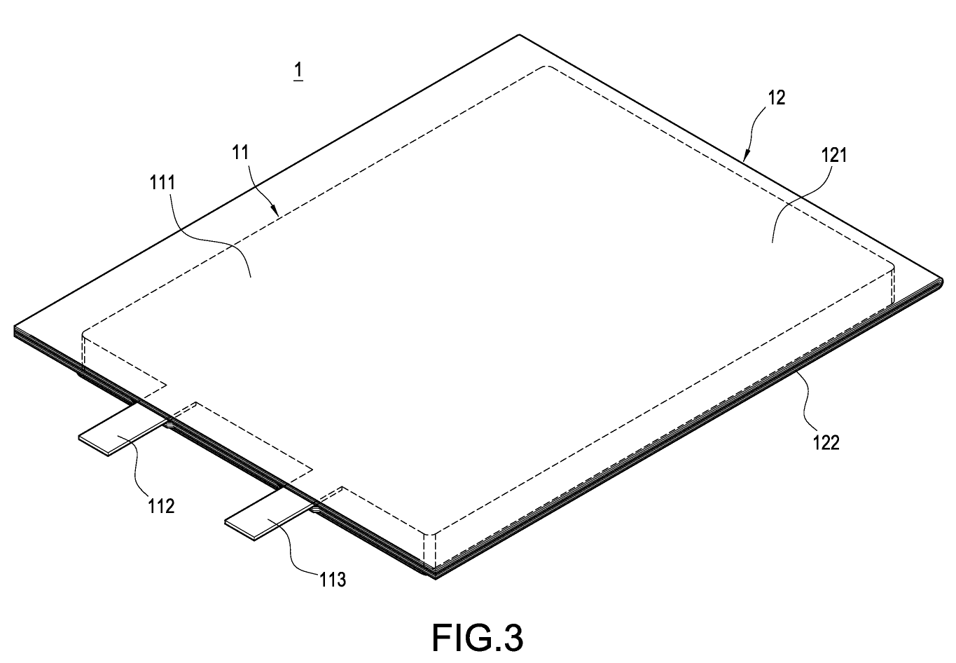

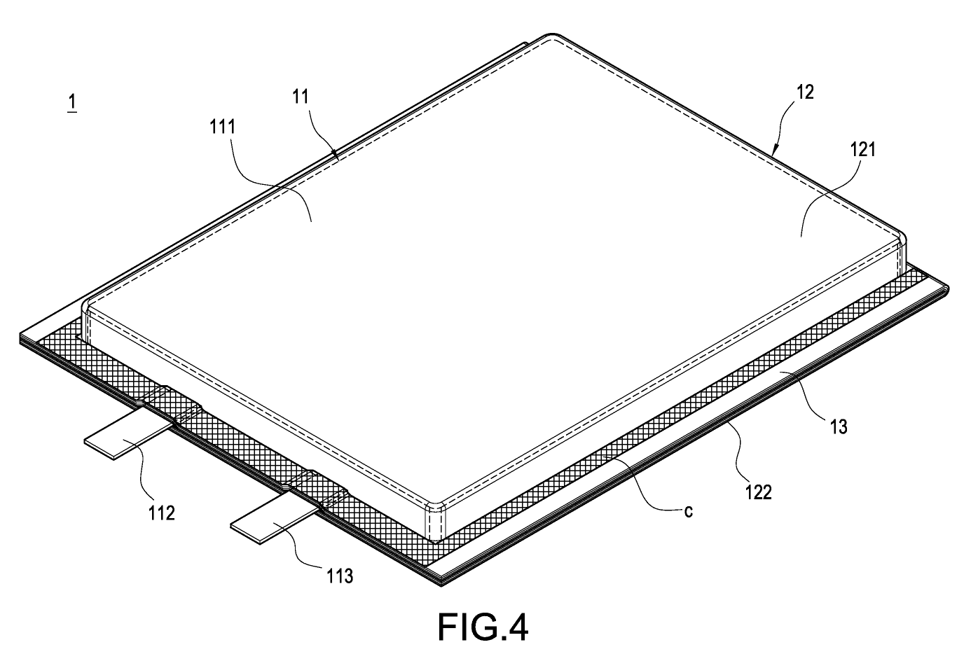

Please refer to FIG. 3 and FIG. 4, showing the manufacturing status perspective views of the invention. After the upper lid plate 121 covers on the indentation b, the upper lid plate 121 surrounding the battery cell 11 is adhered to the lower lid plate 122 by a thermally pressing process with machines and tools, making the upper adhesive part 1211 and the lower adhesive part 1221 adhered to each other, forming the flexible shell 12 and a thermally pressing section c at the outer sides of the flexible shell 12. At this time, the battery cell 11 is completely sealed and enveloped by this flexible shell 12. Only, the positive electrode 111 and the negative electrode 112 are exposed to the outside of this flexible shell 12. Furthermore, there are a plurality of extending parts 13 formed from the upper lid plate 121 and the lower lid plate 122 and located at the outside of the thermally pressing section c and at two sides of the battery cell 11. Meanwhile, the extending parts 13 have a plurality of adhesive layers 1321, 1331 adhered to the supporting seat 20 by a thermally pressing process.

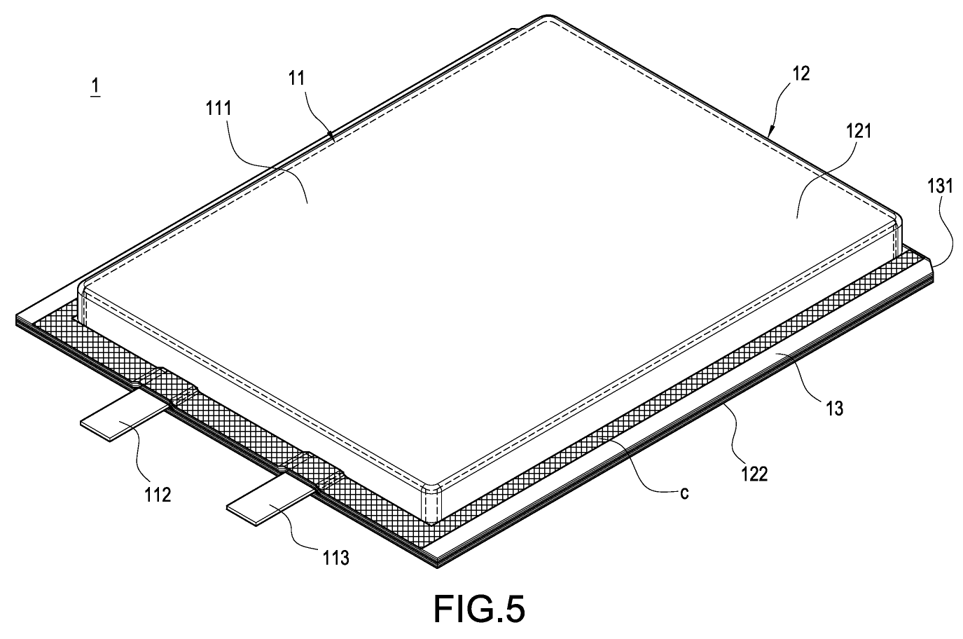

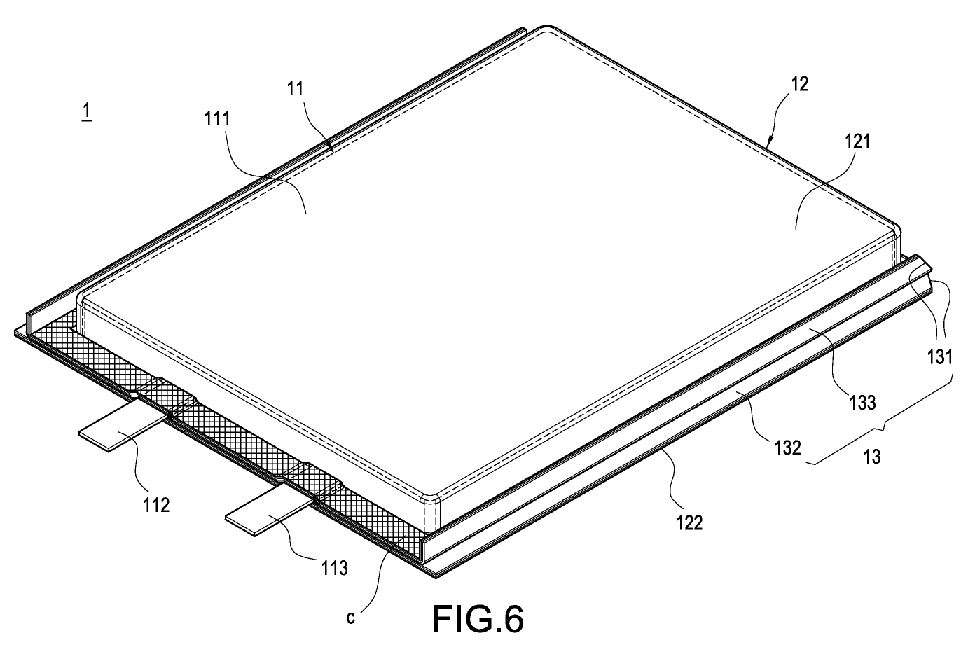

Please refer to FIG. 5 and FIG. 6, also showing the manufacturing status perspective views of the invention. Next, one side of the extending part 13 is clipped into a bevel 131. By so doing, it is easy to inversely fold the extending part 13 to the outside to form an “L” shape and expose the polypropylene layer 12. The extending part 13 includes a first extending part 132 and a second extending part 133 overlapped the first extending part 132. In FIG. 6, the first extending part 132 and the second extending part 133 are vertical to each other, however, not limited to this configuration only. In addition, the first extending part 132 has an adhesive layer 1321, and the second extending part 133 also has an adhesive layer 1331.

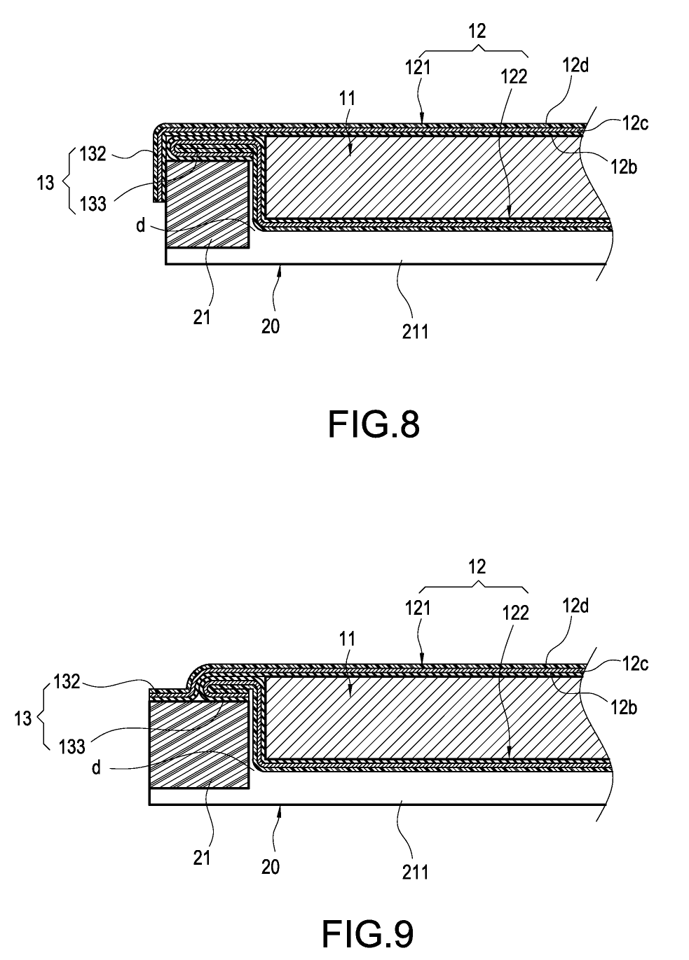

Please refer to FIG. 7 and FIG. 8, respectively showing a perspective explosive view of the invention and a cross-sectional view along the sectional line “8-8” in FIG. 7. The supporting seat 20 includes a plurality of enclosing plates 21 connected to each other. An accommodating space d is formed among these enclosing plates for arranging the flexible shell 12 therein. In this embodiment, the supporting seat 20 is a ring frame shown as a square shape, but not limited to this configuration only. On the other hand, the supporting seat 20 can also be a “U” frame or an “L” frame.

The flexible shell 12 is placed in the accommodating space d, while the upper and lower surfaces of the flexible shell 12 are exposed, such that the heat-transferring efficiency of the battery module 1 can be raised.

The adhesive layer 1321 and the adhesive layer 1331 of the extending part 13, formed as an “L” shape, are respectively connected and adjacent to the top face and the outer wall of the enclosing plate 21. Namely, the first extending part 132 is connect adjacently to the top face of the enclosing plate 21 by adhesion, while the second extending part 133 is folded reversely, making the polypropylene layer 12b connected adjacently to the top face of the enclosing plate 21. In this embodiment, this supporting seat 20 is made of a material of rubber. By the machines and tools (not shown in the figures), the first extending part 132 is adhered to the outer wall of the enclosing plate 21 by a thermally pressing process. Since the first extending part 132 is connected to the enclosing plate 21, the flexible shell 12 and the supporting seat 20 can be jointed securely.

Please refer to FIG. 9, which shows a cross-sectional view of the second embodiment of the invention, which is substantially same as the first embodiment. The only difference between them is that the second extending part 133 is folded reversely with the first extending part 132 adhered to the top face of the enclosing plate 21 by a thermally pressing process. In the meantime, the second extending part 133 is connected adjacently to the top face of the enclosing plate 21 as well. In this embodiment, the first extending part 132 and the second extending part 133, both of which are connected to the top face of the enclosing plate 21, are equal in length.

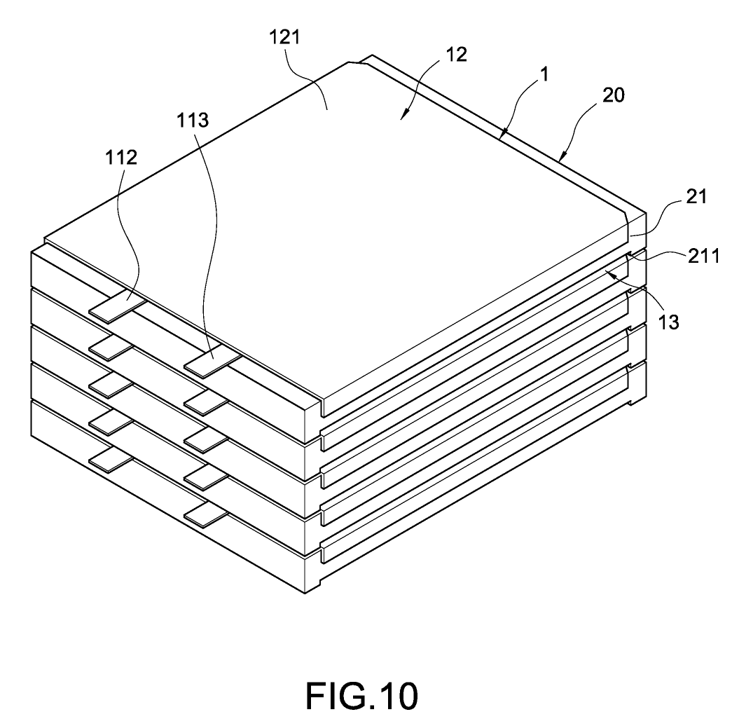

Please refer to FIG. 10, which is a perspective outer view of another embodiment of the invention, in which the battery modules 1 can be stacked over one by one. By overlapping the supporting seats one by one, the number of the battery modules 1 can be varied according to the practical use and need. In addition, a recessing trough 211 is arranged at the bottom of the enclosing plate 21 for the first extending part 132 to pass through, facilitating the aluminum foil layer 12c (please refer to FIG. 9) in processing heat dissipation. In the meantime, the gaps formed by the recessing troughs 211 can facilitate the external air flowing into the space between two battery modules to raise the cooling efficiency. In addition, the battery module 1 further includes an outer shell (not shown in the figures), which seals the battery cell 11, the flexible shell 12 and the supporting seat 20 to form a complete secondary battery.

According to the invention, since the inner layer of the flexible shell is a polypropylene layer, which not only can envelop the battery cell by a thermally pressing and adhering process, but also the polypropylene layer of the extending part of the flexible shell can be adhered to the supporting seat by a thermally pressing process without the use of the double-sided tapes according to the prior arts so, not only the cost is saved, but also the connecting strength between the flexible shell and the supporting seat can be effectively raised.

Summarizing aforementioned description, the invention is an indispensably novel structure for a battery module indeed, which may positively reach the expected usage objective for solving the drawbacks of the prior arts, and which extremely possesses the innovation and progressiveness to completely fulfill the applying merits of new type patent, according to which the invention is thereby applied. Please examine the application carefully and grant it as a formal patent for protecting the rights of the inventor.

However, the aforementioned description is only a number of preferable embodiments according to the present invention, not used to limit the patent scope of the invention, so equivalently structural variation made to the contents of the present invention, for example, description and drawings, is all covered by the claims claimed thereinafter.

What is claimed is:

1. A battery module, including:
a battery cell, which has a main body and two electrodes extended outwardly from the main body;
a flexible shell, which has an upper and lower lid plates, both of which are connected and cooperated to each other to envelop the battery cell, and which are provided for the electrodes to extend out and respectively have an upper and lower adhesive parts, both of which are adhered to each other; and,
a supporting seat, which is provided for arranging the flexible shell;
wherein the flexible shell further has an extending part, which is extended from one of the upper, lower adhesive parts towards the supporting seat and has an adhesive layer adhered to the supporting seat by a thermally press process.

2. The battery module according to claim 1, wherein the upper and lower lid plates are constituent of a polypropylene layer and an aluminum foil layer overlapped the polypropylene layer, and wherein the adhesive layer is made of a material of polypropylene.

3. The battery module according to claim 2, wherein the upper and lower lid plates further include a nylon layer overlapped the aluminum layer.

4. The battery module according to claim 1, wherein the extending part includes a first extending part and a second extending part overlapped the first extending part, on both of which the adhesive layer is located, and wherein the supporting seat includes a plurality of enclosing plates connected to each other and the adhesive layer is connected adjacently to one of the enclosing plates.

5. The battery module according to claim 4, wherein the adhesive layer of the first extending part is adjacently connected by adhering to an outer wall of the enclosing plate, while the second extending part is adjacently connected to a top face of the enclosing plate.

6. The battery module according to claim 4, wherein the adhesive layer of the first extending part is adjacently connected by adhering to a top face of the enclosing plate, while the second extending part is adjacently connected to the top face of the enclosing plate as well.

7. The battery module according to claim 6, wherein the first extending part and the second extending part, both of which are adjacently connected to the top face of the enclosing plate, have a equal length.

8. The battery module according to claim 4, wherein the enclosing plates form an accommodating space for arranging the flexible shell therein.

9. The battery module according to claim 1, wherein an upper surface and a lower surface of the flexible shell are exposed to an outside.
